(19) United States
(12) Patent Application Publication
(10) Pub. No.: US 2009/0264138 A1
(43) Pub. Date: Oct. 22, 2009

(54) METHOD AND SYSTEM FOR TRANSMITTING MULTIMEDIA CONTENTS IN COMMUNICATION NETWORK

(76) Inventors: Bong Ju Kang, Seoul (KR); Min Geun Yoon, Gyeonggi-do (KR); Yun Duk Jeong, Seoul (KR); Soo Jin Kim, Gyeonggi-do (KR); Ki Mun Kim, Incheon (KR); Jin Hong Kim, Seoul (KR)

Correspondence Address: David A. Einhorn, Esq.;Baker & Hostetler LLP, 45 Rockefeller Plaza, New York, NY, 10111, US

(21) Appl. No.: 12/096,064

(22) PCT Filed: Jan. 26, 2007
(86) PCT No.: PCT/KR07/00484

§ 371 Date: Oct. 24, 2008

(30) Foreign Application Priority Data
Jan. 26, 2006 (KR) 10-2006-0008316

(51) Int. Cl. H04W 4/12

(52) U.S. Cl. 455/466

(57) ABSTRACT

Disclosed is a method and system for transmitting multimedia contents in a communication network, wherein multimedia data stored in a subscriber's terminal can be automatically uploaded. The method comprises the steps of (a) transmitting a multimedia data transmission command from a terminal multimedia storage server to a terminal through a communication network; and (b) when the terminal receives the multimedia data transmission command, uploading the multimedia data stored in the terminal to the terminal multimedia storage server in response to the multimedia data transmission command.

### TECHNICAL FIELD

The present invention relates to a method and system for transmitting multimedia contents in a communication network, particularly to a method and system for transmitting multimedia contents in a communication network, wherein multimedia data stored in a subscriber's terminal can be automatically uploaded.

### BACKGROUND ART

According to the development of terminals, most terminals such as laptop computers, cellular phones, and personal digital assistants, are equipped with a digital camera. Thus, a user can easily take a still or motion picture and/or record sound or voice to upload it to a web or WAP page through a communication network irrespective of time or place.

However, inconvenience may occur while uploading the multimedia data stored in a personal terminal to another personal computer or a server of a specwhenic site through a communication network. That is, to that end, the user should connect the terminal having the data to the computer in which the user wants to input the data or should directly request the site to save the data.

### DISCLOSURE OF INVENTION

### Technical Problem

The present invention is provided to overcome the foregoing stated problem which the prior art contains. It is the object of the present invention to provide a method and system for transmitting multimedia contents in a communication network wherein the multimedia data stored in a terminal are automatically uploaded while the user is not using the terminal.

### Technical Solution

In order to achieve the object of the present invention from the first viewpoint, a method for transmitting multimedia contents in a communication network comprises the steps of: (a) transmitting multimedia data transmission command from a terminal multimedia storage server to a terminal through a communication network; and (b) when the terminal receives the multimedia data transmission command, uploading the multimedia data stored in the terminal to the terminal multimedia storage server in response to the multimedia data transmission command.

Preferably, the above method further comprises the step of (c) the terminal multimedia storage server determining whether or not the current time is a predetermined multimedia download time for receiving the multimedia data from the terminal. The terminal multimedia storage server performs step (a) according to the determination at step (c).

Preferably, step (a) comprises the steps of: (a-1) generating the multimedia data transmission command at the terminal multimedia storage server; (a-2) the terminal multimedia storage server requesting SMSC to transmit the multimedia data transmission command to the terminal; and (a-3) in response to the request, the SMSC generating SMS message based on the multimedia data transmission command and sending the SMS to the terminal.

Preferably, step (b) comprises the steps of: (b-1) when the terminal receives the multimedia data transmission command, in response to the multimedia data transmission command, the terminal communicating with the terminal multimedia storage server to build a data communication path between the terminal and the terminal multimedia storage server; and (b-2), when the data communication path is built, the terminal uploading the multimedia data to the terminal multimedia storage server through the data communication path. More preferably, step (b) further comprises the step of (b-3), when the terminal receives the multimedia data transmission command, the terminal determining whether there are multimedia data which have not been transmitted. When there are multimedia data which have not been transmitted, step (b-1) is performed, and the remaining multimedia data are uploaded at step (b-2).

Preferably, step (b) further comprises the step of (b-4), when the multimedia data are uploaded to the terminal multimedia storage server through step (b), storing the results of the upload.

In order to achieve the object of the present invention from the second viewpoint, a method for transmitting multimedia contents in a communication network comprises the steps of: (a) the multimedia storage server generating the multimedia data transmission command; (b) the terminal multimedia storage server requesting the SMSC to transmit the multimedia data transmission command to the terminal; (c) in response to the request, the SMSC generating an SMS message based on the multimedia data transmission command and sending the SMS to the terminal; (d) when the terminal receives the multimedia data transmission command, in response to the multimedia data transmission command, the terminal communicating with the terminal multimedia storage server to build a data communication path between the terminal and the terminal multimedia storage server; and (e) when the data communication path is built, the terminal uploading the multimedia data to the terminal multimedia storage server through the data communication path.

Preferably, the method further comprises the step of (f) the terminal multimedia storage server determining whether or not the current time is a predetermined multimedia download time for receiving the multimedia data from the terminal. When the current time is a predetermined multimedia download time as a result of the determination at step (f), the terminal multimedia storage server performs step (a).

Preferably, the method further comprises the step of (g) when the terminal receives the multimedia data transmission command, the terminal determining whether there are any multimedia data which have not been transmitted before performing step (d). As a result of step (g), when there are multimedia data which have not been transmitted, step (d) is performed, and the data which have not been transmitted are uploaded at step (e).

More preferably, the method further comprises the steps of, when the multimedia data are uploaded to the terminal multimedia storage server by step (b), the terminal storing the result of the upload.

In order to achieve the object of the present invention from the third viewpoint, a method for transmitting multimedia contents in a communication network comprises the steps of: (a), when a multimedia data uploading is requested from a terminal, a terminal multimedia storage server determining whether to approve the uploading request and sending the determination to the terminal; and (b), when the terminal multimedia storage server approves the multimedia data uploading request, uploading the multimedia data stored in the terminal to the terminal multimedia storage server.

Preferably, the method further comprises the step of (c) the terminal determining whether or not the current time is a predetermined multimedia upload time. According to the determination at step (c), the terminal performs step (a).

Preferably, the predetermined multimedia upload time is set in the terminal by a user of the terminal. And the predetermined multimedia upload time is determined as a time period of minimum traffic.

Preferably, step (a) comprises the steps of: (a-1) the terminal requesting the multimedia storage server to upload the multimedia data; and (a-2), when the request for uploading the multimedia data is received from the terminal through step (a-1), the terminal multimedia storage server determining whether to approve the uploading request and sending the determination to the terminal.

Preferably, the method further comprises the step of (d) the terminal determining whether or not there are any multimedia data which have not been transmitted. As a result of step (d), when there are multimedia data which have not been transmitted, step (a) or (c) is performed, and the remaining multimedia data are uploaded in step (b).

Preferably, step (b) comprises the steps of: (b-1), when the terminal multimedia storage server approves the uploading of the multimedia data as a result of step (a), the terminal communicating with the terminal multimedia storage server to build a data communication path; and (b-2) uploading the multimedia data from the terminal to the terminal multimedia storage server through the data communication path built at step (b-1).

Preferably, step (b-3) further comprises the step of, when the multimedia data are uploaded to the terminal multimedia storage server through step b-2), the terminal storing the result of the uploading.

In order to achieve the object of the present invention from the fourth viewpoint, a method for transmitting multimedia contents in a communication network comprises the steps of: (a) a terminal determining whether or not the current time is a predetermined multimedia upload time; (b) when the current time is the predetermined multimedia upload time as a result of step (a), the terminal determining whether there are multimedia data which have not been transmitted; (c) when there are data which have not been transmitted as a result of step (b), the terminal requesting the terminal multimedia storage server to upload the multimedia data; (d) when the request for uploading the multimedia data is received from the terminal as a result of step (c), the terminal multimedia storage server determining whether to approve the uploading request and sending the determination to the terminal; and (e) when the terminal multimedia storage server approves the uploading request, the terminal uploading the multimedia data, which have not been transmitted, to the terminal multimedia storage server.

Preferably, step (e) comprises the steps of: (e-1) when the terminal multimedia storage server approves the uploading of the multimedia data as a result of step (d), the terminal communicating with the terminal multimedia storage server to build a data communication path; and (e-2) uploading the multimedia data from the terminal to the terminal multimedia storage server through the data communication path built by step (e-1).

More preferably, the method further comprises the step of (e-3) when the multimedia data are uploaded to the terminal multimedia storage server through step (e-2), the terminal storing the result of the uploading.

In order to achieve the object of the present invention from the fifth viewpoint, a system for transmitting multimedia contents in a communication network comprises: a terminal multimedia storage server for transmitting a multimedia data transmission command to a terminal through a communication network, and, when the multimedia data are received from the terminal, for storing the multimedia data to correspond to the terminal; and a terminal, when the multimedia data transmission command is received, for uploading the multimedia data stored in the terminal to the terminal multimedia storage server in response to the multimedia data transmission command.

Preferably, the terminal multimedia storage server determines whether the current time is a multimedia download time predetermined for receiving the multimedia data from the terminal, and sends the multimedia data transmission command to the terminal according to the result of the determination. More preferably, the predetermined multimedia download time is set in the terminal multimedia storage server by a user of the terminal. According to an embodiment, the predetermined multimedia upload time is determined as a time period of minimum traffic.

Also, the system receives the request for transmitting the multimedia data transmission command from the terminal multimedia storage server, it generates an SMS message based on the multimedia data transmission command. The system further comprises an SMSC for transmitting the SMS message. Thus, the terminal multimedia storage server requests the SMSC to send the multimedia data transmission command to the terminal.

Preferably, when the terminal receives the multimedia data transmission command, the terminal, in response to the multimedia data transmission command, communicates with the terminal multimedia storage server to build a data communication path. When the data communication path is built, the multimedia data are uploaded to the terminal multimedia storage server through the data communication path. Also, when the terminal receives the multimedia data transmission command, it determines whether or not there are any data which have not been transmitted. When it is determined that data which have not been transmitted exist, the multimedia data which have not been transmitted are uploaded. Also, it is preferable that the terminal saves the result of the upload of the multimedia data to the terminal multimedia storage server.

In order to achieve the object of the present invention from the sixth viewpoint, a system for transmitting multimedia contents in a communication network comprises: a terminal multimedia storage server for generating a multimedia data transmission command and for requesting an SMSC to send the multimedia data transmission command to a terminal; the SMSC for generating an SMS message based on the multimedia data transmission command in response to the request from the terminal multimedia storage server and for sending the SMS message to the terminal; and the terminal, when the SMS message including the multimedia data transmission command is received, for communicating with the terminal multimedia storage server to build a data communication path between the terminal and the terminal multimedia storage server, and, when the data communication path is built, for uploading the multimedia data to the terminal multimedia storage server through the data communication path.

Preferably, when the terminal receives the multimedia data transmission command, the terminal determines whether or not there are any data which have not been transmitted. When it is determined that data which have not been transmitted exist, the multimedia data which have not been transmitted are uploaded, and the result of the upload of the multimedia data to the terminal multimedia storage server is stored.

In order to achieve the object of the present invention from the seventh viewpoint, a system for transmitting multimedia contents in a communication network comprises: a terminal multimedia storage server for determining whether to approve a request for uploading multimedia data from a terminal, for sending the result of the determination to the terminal, and for storing the multimedia data from the terminal; and the terminal, when the terminal multimedia storage server approves the uploading of the multimedia data as a result of the determination, for uploading the stored multimedia data to the terminal multimedia storage server.

Preferably, the terminal determines whether or not there are any data which have not been transmitted. When it is determined that data which have not been transmitted exist, the data which have not been transmitted are uploaded.

Preferably, when the terminal multimedia storage server approves the uploading of the multimedia data as a result of the determination, the terminal communicates with the terminal multimedia storage server to build a data communication path and uploads the multimedia data to the terminal multimedia storage server through the built data communication path.

In order to achieve the object of the present invention from the eighth viewpoint, a system for transmitting multimedia contents in a communication network comprises: a terminal for determining whether or not the current time is a predetermined multimedia upload time, for determining whether or not there are multimedia data which have not been transmitted when the current time is the predetermined multimedia upload time as a result of the determination, and requesting a terminal multimedia storage server to upload the multimedia data; and the terminal multimedia storage server for determining whether to approve the request for uploading the multimedia data which were transmitted from the terminal, and for sending the result of the determination to the terminal, wherein when the terminal multimedia storage server approves the uploading of the multimedia data, the terminal uploads the multimedia data which have not been transmitted to the terminal multimedia storage server.

Preferably, when the terminal multimedia storage server approves the uploading of the multimedia data as a result of the determination, the terminal communicates with the terminal multimedia storage server to build a data communication path through which the multimedia data are uploaded to the terminal multimedia storage server.

More preferably, when the uploading of the multimedia data is finished or stops, the terminal stores the result.

### ADVANTAGEOUS EFFECTS

According to the embodiments stated above, the multimedia data stored by a user are automatically uploaded while the user is not using the terminal, so that the user can conveniently upload multimedia data.

As stated above, the present invention accomplishes a method and system for transmitting multimedia contents in a communication network wherein the multimedia data stored in a terminal are automatically uploaded while the user is not using the terminal.

It is understood by those skilled in the art that various changes or modwhenications may be made in the above embodiment of the present invention without departing from the spirit and scope of the invention.

### BRIEF DESCRIPTION OF THE DRAWINGS

FIG. 1 is a diagram showing a system for transmitting multimedia data through a communication network according to the embodiment of the present invention;

FIG. 2 is a signal flow chart showing an example of the process of multimedia data transmission through a communication network in the system shown in FIG. 1 according to one embodiment of the present invention; and

FIG. 3 is a signal flow chart showing an example of the process of multimedia data transmission through a communication network in the system shown in FIG. 1 according to another embodiment of the present invention.

### BEST MODE FOR CARRYING OUT THE INVENTION

Hereinafter, the present invention will be illustrated more specwhenically in reference to the drawings attached hereto.

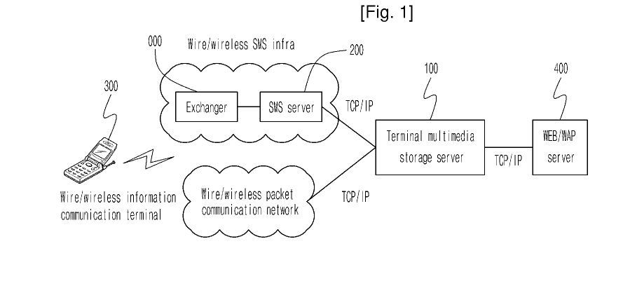

FIG. 1 is a diagram showing a system for transmitting multimedia data through a communication network according to an embodiment of the present invention.

### Embodiment 1

Referring to FIG. 1, a system for transmitting multimedia data through a communication network according to the first embodiment of the present invention comprises a terminal multimedia storage server 100 and an SMSC 200.

The terminal multimedia storage server 100 generates a multimedia data transmission command according to the present invention and requests the SMSC 200 to send the generated multimedia data transmission command to a terminal of a user.

When the SMSC 200 receives the request for transmitting the message from the terminal multimedia storage server 100, the SMSC 200, in response to the request, generates an SMS message based on the multimedia data transmission command and sends the SMS message to the terminal 300 through a wire or wireless communication network.

When the terminal 300 receives the SMS message containing the multimedia data transmission command, the terminal 300 communicates with the terminal multimedia storage server 100 to build a data communication path with the terminal multimedia storage server 100 in accordance with the multimedia data transmission command. When the data communication path is built, the terminal 300 uploads the multimedia data to the terminal multimedia storage server 100 through the data communication path.

Preferably, the terminal multimedia storage server 100 determines whether the current time is a predetermined multimedia download time when it should receive the multimedia data from the terminal. As a result, when the current time is the predetermined multimedia download time, the terminal multimedia storage server 100 generates the multimedia data transmission command.

According to embodiments, the predetermined multimedia download time is set in the terminal multimedia storage server 100 by the user of the terminal 300. Also, the predetermined multimedia download time is determined as a time period of minimum traffic. For instance, when the user calls the least during the time period 2-5 a.m., the data download time of the terminal 300 can be set as 2-5 a.m.

Preferably, when the terminal 300 receives the multimedia data transmission command, the terminal 300 determines whether there are multimedia data which have yet to be transmitted. As a result, when there are multimedia data which have yet to be transmitted, the terminal 300 uploads the multimedia data as stated above.

Preferably, the terminal 300 stores the result of the uploading of the multimedia data to the terminal multimedia storage server 100, and afterwards utilizes it. That is, only the file which has not been uploaded can be uploaded in the next uploading.

Hereinafter, with reference to the drawings attached hereto, the system according to the first embodiment of the present invention will be specifically explained along with the operation.

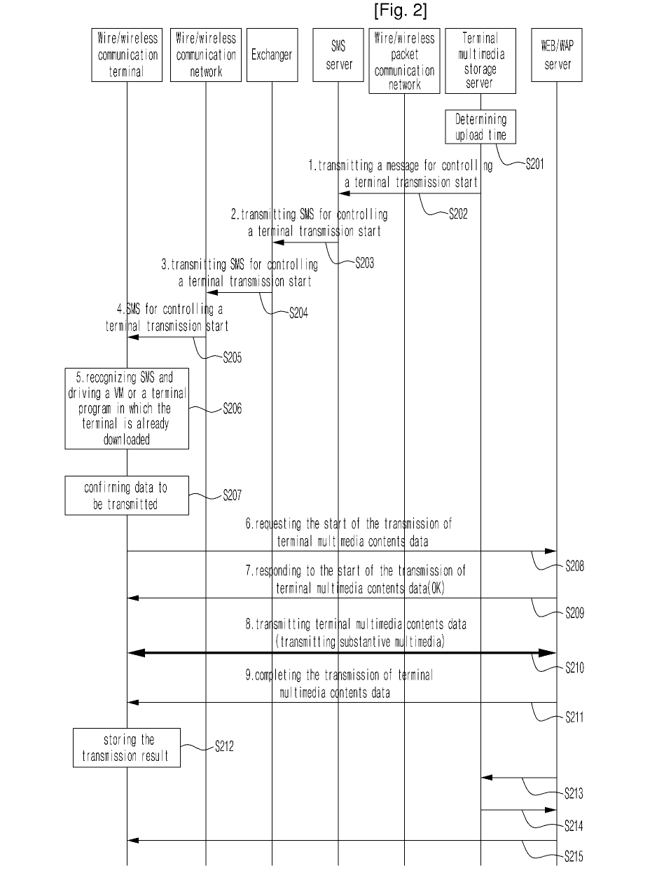

FIG. 2 is a signal flow chart showing an example of the process of multimedia data transmission through a communication network in the system shown in FIG. 1

Referring to FIG. 2, firstly, the terminal multimedia storage server 100 determines whether the current time is a predetermined multimedia download time when it should receive the multimedia data from the terminal (S201).

As a result of step S201, when the current time is the predetermined multimedia download time, the terminal multimedia storage server 100 generates the multimedia data transmission command and requests the SMSC 200 to send the multimedia data transmission command to the terminal (S202).

When the SMSC 200 receives the request for transmitting the message from the terminal multimedia storage server 100, the SMSC 200, in response to the request, generates an SMS message based on the multimedia data transmission command and sends the SMS message to the terminal 300 through a communication network (S203-S205).

Then, when the terminal 300 receives the SMS message containing the multimedia data transmission command, the terminal 300 communicates with the terminal multimedia storage server 100 to build a data communication path between the terminal and the terminal multimedia storage server 100 in accordance with the multimedia data transmission command. That is, the terminal 300 requests the terminal multimedia storage server 100 to build a data communication path and the data communication path is built by the response of the terminal multimedia storage server 100. Preferably, the terminal 300 has an exclusive program for a multimedia data transmission installed therein. The exclusive program is driven when the terminal 300 receives the multimedia data transmission command and stops when the multimedia data transmission is completed according to the present invention. Also, preferably, when the terminal 300 receives the multimedia data transmission command, the terminal 300 determines whether there are multimedia data which have yet to be transmitted. As a result, when there are multimedia data which have yet to be transmitted, the terminal 300 sends the multimedia data which have not yet been transmitted (S206-S208).

When the data communication path is built, the terminal 300 uploads the multimedia data to the terminal multimedia storage server 100 through the data communication path. When the upload of the multimedia data to the terminal multimedia storage server 100 is completed, the terminal 300 stores the upload result (S209-212).

Meanwhile, when the user requests the sending of the uploaded multimedia file to a WAP or web server 400, the WAP or web server 400 requests the terminal multimedia storage server 100 for the multimedia data which the user has uploaded. When the WAP or web server 400 receives the multimedia data from the terminal multimedia storage server 100 in response to the request, it sends the received multimedia data to a wire or wireless terminal of the user, e.g., a personal computer (not shown) or the terminal 300 (S213-215).

### Embodiment 2

By referring to FIG. 1, the second embodiment of the present invention is explained hereunder.

Referring to FIG. 1, a system for transmitting multimedia data through a communication network according to the second embodiment of the present invention comprises a terminal 300 and a terminal multimedia storage server 100.

The terminal 300 according to the present invention determines whether the current time is a predetermined multimedia upload time. When the current time is the predetermined multimedia upload time as a result of the determination, the terminal 300 determines whether there are multimedia data which have yet to be transmitted in the terminal 300. When there are multimedia data which have yet to be transmitted as a result of the determination, the terminal 300 requests the terminal multimedia storage server 100 to upload the multimedia data.

When the terminal multimedia storage server 100 receives the request for uploading the multimedia data from the terminal 300, the terminal multimedia storage server 100 determines whether to approve the upload request and send the result to the terminal 300.

When the terminal multimedia storage server 100 approves the upload of the multimedia data, the terminal 300 uploads the multimedia data which have not yet been transmitted to the terminal multimedia storage server 100.

Preferably, the predetermined multimedia upload time is set in the terminal by the user of the terminal. More preferably, the predetermined multimedia upload time is determined as the minimum of the call time periods of the terminal.

Preferably, when the terminal multimedia storage server 100 approves the upload of the multimedia data as a result of the above determination, the terminal 300 communicates with the terminal multimedia storage server to build a data communication path to upload the multimedia data to the terminal multimedia storage server.

Also, when uploading the multimedia data to the terminal multimedia storage server 100 is completed or stops, the terminal 300 stores the result.

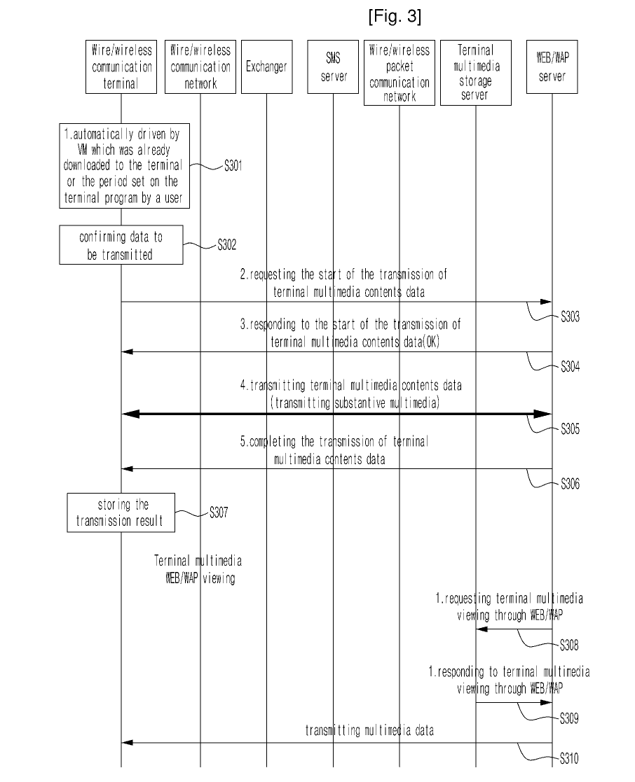

Hereinafter, with reference to FIG. 3, the operation of the system according to the present invention stated above will be illustrated.

The terminal 300 determines whether or not the current time is a predetermined multimedia upload time (S301).

As a result of the determination of step S301, when the current time is the predetermined multimedia upload time, the terminal 300 determines whether there are multimedia data which have yet to be transmitted (S302).

As a result of the determination of step S302, when there are multimedia data which have yet to be transmitted, the terminal 300 requests the terminal multimedia storage server 100 to upload the multimedia data (S303).

When the terminal multimedia storage server 100 receives the request for uploading the multimedia data from the terminal 300 through step S303, the terminal multimedia storage server 100 determines whether to approve the request for upload and sends the result to the terminal 300 (S304).

When the terminal multimedia storage server 100 approves the upload of the multimedia data in step S304, the terminal 300 uploads the multimedia data which have not yet been transmitted to the terminal multimedia storage server 100 (S305 and 306).

Then, when the multimedia data are uploaded to the terminal multimedia storage server 100, the terminal 300 stores the upload result (S307).

Meanwhile, when the user requests for sending the uploaded multimedia file to a WAP or web server 400, the WAP or web server 400 requests the terminal multimedia storage server 100 for the multimedia data which the user has uploaded. When the WAP or web server 400 receives the multimedia data from the terminal multimedia storage server 100 in response to the request, it sends the received multimedia data to a wire or wireless terminal of the user, e.g., a personal computer (not shown) or the terminal 300 (S308-310).

1. A method for transmitting multimedia contents in a communication network comprising the steps of: (a) transmitting a multimedia data transmission command from a terminal multimedia storage server to a terminal through a communication network; and (b) when the terminal receives the multimedia data transmission command, uploading the multimedia data stored in the terminal to the terminal multimedia storage server in response to the multimedia data transmission command.

2. The method according to claim 1 further comprising the step of (c) the terminal multimedia storage server determining whether or not the current time is a predetermined multimedia download time for receiving the multimedia data from the terminal, wherein the terminal multimedia storage server performs step (a) according to the determination at step (c).

3. The method according to claim 2, wherein the predetermined multimedia upload time is set in the terminal by a user of the terminal.

4. The method according to claim 2, wherein the predetermined multimedia upload time is determined as a time period of minimum traffic.

5. The method according to one of claims 1-4, wherein step (a) comprises the steps of: (a-1) generating the multimedia data transmission command at the terminal multimedia storage server; (a-2) the terminal multimedia storage server requesting an SMSC to transmit the multimedia data transmission command to the terminal; and (a-3) in response to the request, the SMSC generating an SMS message based on the multimedia data transmission command and sending the SMS message to the terminal.

6. The method according to one of claims 1-4, wherein step (b) comprises the steps of: (b-1) when the terminal receives the multimedia data transmission command, in response to the multimedia data transmission command, the terminal communicating with the terminal multimedia storage server to build a data communication path between the terminal and the terminal multimedia storage server; and (b-2), when the data communication path is built, the terminal uploading the multimedia data to the terminal multimedia storage server through the data communication path.

7. The method according to claim 6, wherein step (b) further comprises the step of (b-3), when the terminal receives the multimedia data transmission command, the terminal determining whether there are multimedia data which have not transmitted to the terminal multimedia storage server, and as a result of step (b-3), when there are multimedia data which have not, step (b-1) is performed so that the multimedia data which have not transmitted are uploaded at step (b-2).

8. The method according to claim 7 further comprising the step of (b-4), when the multimedia data are uploaded to the terminal multimedia storage server through step (b), storing the results of the upload.

9. A method for transmitting multimedia contents in a communication network comprising the steps of: (a) a terminal multimedia storage server generating a multimedia data transmission command; (b) the terminal multimedia storage server requesting an SMSC to transmit the multimedia data transmission command to a terminal; (c) in response to the request, the SMSC generating an SMS message based on the multimedia data transmission command and sending the SMS message to the terminal; (d) when the terminal receives the multimedia data transmission command, in response to the multimedia data transmission command, the terminal communicating with the terminal multimedia storage server to build a data communication path between the terminal and the terminal multimedia storage server; and (e) when the data communication path is built, the terminal uploading the multimedia data to the terminal multimedia storage server through the data communication path.

10. The method according to claim 9 further comprising the step of (f) the terminal multimedia storage server determining whether or not the current time is a predetermined multimedia download time for receiving the multimedia data from the terminal, and, when the current time is a predetermined multimedia download time as a result of the determination at step (f), the terminal multimedia storage server performs step (a).

11. The method according to claim 10, wherein the predetermined multimedia download time is set in the terminal multimedia storage server by a user of the terminal.

12. The method according to claim 10, wherein the predetermined multimedia download time is determined as a time period of minimum traffic.

13. The method according to one of claims 9-12 further comprising the step of (g) when the terminal receives the multimedia data transmission command, the terminal determining whether there are any multimedia data which have not been transmitted to the terminal multimedia storage server before performing step (d), and, when there are multimedia data which have not been transmitted as a result of step (g), step (d) is performed so that the data which have not been transmitted are uploaded at step (e).

14. The method according to claim 13 further comprising the step of (h) when the multimedia data are uploaded to the terminal multimedia storage server through step (b), the terminal storing the result of the upload.

15. A method for transmitting multimedia contents in a communication network comprising the steps of: (a), when a multimedia data uploading is requested from a terminal, a terminal multimedia storage server determining whether to approve the uploading request and sending the determination to the terminal; and (b), when the terminal multimedia storage server approves the uploading request, the terminal uploading the multimedia data stored in the terminal to the terminal multimedia storage server.

16. The method according to claim 15 further comprising the step of (c) the terminal determining whether or not the current time is a predetermined multimedia upload time and performing step (a) according to the determination at step (c).

17. The method according to claim 16, wherein the predetermined multimedia upload time is set in the terminal by a user of the terminal.

18. The method according to claim 16, wherein the predetermined multimedia upload time is determined as a time period of minimum traffic.

19. The method according to one of claims 15-18, wherein step (a) comprises the steps of: (a-1) the terminal requesting the multimedia storage server to upload the multimedia data; and (a-2), when the request for uploading the multimedia data is received from the terminal through step (a-1), the terminal multimedia storage server determining whether to approve the uploading request and sending the determination to the terminal.

20. The method according to one of claims 15-18 further comprising the step of (d) the terminal determining whether or not there are multimedia data which have not been transmitted to the terminal multimedia storage server, wherein when there are multimedia data which have not yet been transmitted as a result of step (d), step (a) or (c) is performed, and the multimedia data which have not yet been transmitted are uploaded in step (b).

21. The method according to one of claims 15-18, wherein step (b) comprises the steps of: (b-1), when the terminal multimedia storage server approves the uploading of the multimedia data as a result of step (a), the terminal communicating with the terminal multimedia storage server to build a data communication path; and (b-2) uploading the multimedia data from the terminal to the terminal multimedia storage server through the data communication path built at step (b-1).

22. The method according to claim 20 further comprising the step of (b-3), when the multimedia data are uploaded to the terminal multimedia storage server through step b-2), the terminal storing the result of the upload.

23. A method for transmitting multimedia contents in a communication network comprising the steps of: (a) a terminal determining whether or not the current time is a predetermined multimedia upload time; (b) when the current time is the predetermined multimedia upload time as a result of step (a), the terminal determining whether there are multimedia data which have not been transmitted; (c) when there are data which have not been transmitted as a result of step (b), the terminal requesting the terminal multimedia storage server to upload the multimedia data; (d) when the request for uploading the multimedia data is received from the terminal as a result of step (c), the terminal multimedia storage server determining whether to approve the uploading request and sending the determination to the terminal; and (e) when the terminal multimedia storage server approves the uploading request, the terminal uploading the multimedia data, which has not yet been transmitted, to the terminal multimedia storage server.

24. The method according to claim 23, wherein the predetermined multimedia upload time is set in the terminal by a user of the terminal.

25. The method according to claim 23, wherein the predetermined multimedia upload time is determined as a time period of minimum traffic.

26. The method according to one of claims 23-25, wherein step (e) comprises the steps of: (e-1) when the terminal multimedia storage server approves the uploading of the multimedia data as a result of step (d), the terminal communicating with the terminal multimedia storage server to build a data communication path; and (e-2) uploading the multimedia data from the terminal to the terminal multimedia storage server through the data communication path built by step (e-1).

27. The method according to claim 26 further comprising the step of (e-3) when the multimedia data are uploaded to the terminal multimedia storage server through step (e-2), the terminal storing the result of the upload.

28. A system for transmitting multimedia contents in a communication network comprising: a terminal multimedia storage server for transmitting a multimedia data transmission command to a terminal through a communication network, and, when the multimedia data are received from the terminal, for storing the multimedia data; and a terminal, when the multimedia data transmission command is received, for uploading the multimedia data stored in the terminal to the terminal multimedia storage server in response to the multimedia data transmission command.

29. The system according to claim 28, wherein the terminal multimedia storage server determines whether the current time is a multimedia download time predetermined for receiving the multimedia data from the terminal, and sends the multimedia data transmission command to the terminal according to the result of the determination.

30. The system according to claim 29, wherein the predetermined multimedia download time is set in the terminal multimedia storage server by a user of the terminal.

31. The system according to claim 29, wherein the predetermined multimedia upload time is determined as a time period of minimum traffic.

32. The system according to one of claims 28-31 further comprising an SMSC, when a request for sending the multimedia data transmission command is received from the terminal multimedia storage server, for generating an SMS message based on the multimedia data transmission command and for sending the SMS message to the terminal, wherein the terminal multimedia storage server requests the SMSC to send the multimedia data transmission command to the terminal.

33. The system according to one of claims 28-31, wherein, when the terminal receives the multimedia data transmission command, in response to the multimedia data transmission command, the terminal communicates with the terminal multimedia storage server to build a data communication path, and, when the data communication path is built, the multimedia data are uploaded to the terminal multimedia storage server through the data communication path.

34. The system according to claim 33, wherein when the terminal receives the multimedia data transmission command, the terminal determines whether or not there are multimedia data which have not been transmitted, and, when it is determined that multimedia data which have not yet been transmitted exist, the multimedia data which have not been transmitted are uploaded.

35. The system according to claim 34, wherein the terminal stores the result of the upload of the multimedia data to the terminal multimedia storage server.

36. A system for transmitting multimedia contents in a communication network comprising: a terminal multimedia storage server for generating a multimedia data transmission command and for requesting an SMSC to send the multimedia data transmission command to a terminal; an SMSC for generating an SMS message based on the multimedia data transmission command in response to the request from the terminal multimedia storage server and for sending the SMS message to the terminal; and a terminal, when the SMS message including the multimedia data transmission command is received, for communicating with the terminal multimedia storage server to build a data communication path between the terminal and the terminal multimedia storage server, and, when the data communication path is built, for uploading the multimedia data to the terminal multimedia storage server through the data communication path.

37. The system according to claim 36, wherein the terminal multimedia storage server determines whether the current time is a multimedia download time predetermined for receiving the multimedia data from the terminal, and when it is determined that the current time is the predetermined download time, it generates the multimedia data transmission command.

38. The system according to claim 37, wherein the predetermined multimedia download time is set in the terminal multimedia storage server by a user of the terminal.

39. The system according to claim 37, wherein the predetermined multimedia download time is determined as a time period of minimum traffic.

40. The system according to one of claims 36-39, wherein when the terminal receives the multimedia data transmission command, the terminal determines whether or not there are multimedia data which have not been transmitted, and, when it is determined that multimedia data which have not yet been transmitted exist, the multimedia data which have not been transmitted are uploaded.

41. The system according to claim 40, wherein the terminal stores the result of the upload of the multimedia data to the terminal multimedia storage server.

42. A system for transmitting multimedia contents in a communication network comprising: a terminal multimedia storage server for determining whether to approve a request for uploading multimedia data from a terminal, for sending the result of the determination to the terminal, and for storing the multimedia data from the terminal; and the terminal, when the terminal multimedia storage server approves the uploading of the multimedia data as a result of the determination, for uploading the stored multimedia data to the terminal multimedia storage server.

43. The system according to claim 42, wherein the terminal determines whether the current time is a predetermined multimedia download time, and when it is determined that the current time is the predetermined download time, it requests the terminal multimedia storage server to upload the multimedia data

44. The system according to claim 43, wherein the predetermined multimedia download time is set in the terminal by a user of the terminal.

45. The system according to claim 43, wherein the predetermined multimedia download time is determined as a time period of minimum traffic.

46. The system according to one of claims 42-45, wherein the terminal determines whether or not there are any multimedia data which have not been transmitted, and, when multimedia it is determined that data which have not yet been transmitted exist, the multimedia data which have not yet been transmitted are uploaded.

47. The system according to one of claims 42-45, wherein when the terminal multimedia storage server approves the uploading of the multimedia data as a result of the determination, the terminal communicates with the terminal multimedia storage server to build a data communication path and uploads the multimedia data to the terminal multimedia storage server through the built data communication path.

48. The system according to claim 47, wherein when the multimedia data are uploaded to the terminal multimedia storage server, the terminal stores the result of the upload.

49. A system for transmitting multimedia contents in a communication network comprising: a terminal for determining whether or not the current time is a predetermined multimedia upload time, for determining whether or not there are multimedia data which have not been transmitted when the current time is the predetermined multimedia upload time as a result of the determination, and requesting a terminal multimedia storage server to upload the multimedia data when there are multimedia data which have not been transmitted; and the terminal multimedia storage server for determining whether to approve the request for uploading the multimedia data which are transmitted from the terminal, and for sending the result of the determination to the terminal, wherein, when the terminal multimedia storage server approves the uploading of the multimedia data, the terminal uploads the multimedia data which have not been transmitted to the terminal multimedia storage server.

50. The system according to claim 49, wherein the predetermined multimedia upload time is set in the terminal by a user of the terminal.

51. The system according to claim 50, wherein the predetermined multimedia upload time is determined as a time period of minimum traffic.

52. The system according to one of claims 49-51, wherein when the terminal multimedia storage server approves the uploading of the multimedia data as a result of the determination, the terminal communicates with the terminal multimedia storage server to build a data communication path through which the multimedia data are uploaded to the terminal multimedia storage server.

53. The system according to claim 52, wherein when the uploading of the multimedia data is finished or stops, the terminal stores the result.
